(19) United States
(12) Patent Application Publication
(10) Pub. No.: US 2003/0093796 A1
(43) Pub. Date: May 15, 2003

(54) Viewing promoting system and viewing promoting device, and recording medium

(76) Inventor: Kazumi Mizuguchi, Nagoya-shi (JP)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/258,400

(22) PCT Filed: Apr. 25, 2001
(86) PCT No.: PCT/JP01/03593

(51) Int. Cl. H04N 7/16; G06F 15/16; G06F 3/00; H04N 5/445; G06F 13/00; H04N 7/173

(52) U.S. Cl. 725/58; 709/206; 709/217; 725/109; 725/135; 725/134; 725/142

(57) ABSTRACT

A system and apparatus for encouraging viewing of broadcast contents. When a mail receiving terminal receives e-mail including a message that a CM by an advertiser will be broadcasted from a mail server, a program record button (64), a program view button (65), a CM record button (66) and a CM view button (67) as well as the message that the CM by the advertiser will be broadcasted are displayed on a mailer screen (50). The mail also includes program information such as the program start date and time, the program finish date and time, the CM start date and time, the CM finish date and time and the broadcast channel. When the CM record button (66) is clicked, a CM recording reservation signal is transmitted to a VCR in accordance with the program information through the infrared interface of the mail receiving terminal.

### TECHNICAL FIELD

The present invention relates to a system and an apparatus for encouraging viewing of broadcast contents.

### BACKGROUND OF THE ART

To encourage viewing of the broadcast contents of television and radio, program advertisements through broadcast and provision of program listings through magazines, newspapers and the Internet have been utilized. A viewer, who decides a program to view based on the information acquired through these media, actually turns on the television or the radio and views the program during its broadcast, or makes a recording reservation on the VCR or the component stereo for the program before its broadcast and views the program after the broadcast.

However, the viewer sometimes forgets to view and, as a result, misses the broadcast although planning to view it during its broadcast. The viewer also may sometimes forget the broadcast time or the broadcast channel of the program and miss it.

On the other hand, if the viewer is to make a picture recording reservation or a sound recording reservation of the VCR or the component stereo, it is necessary to set the broadcast date and time as well as the broadcast channel on the VCR or the component stereo. Such setting involves the problem that the viewer should remember the broadcast date and time as well as the broadcast channel and directly input the same through the main body or the remote controller for the VCR or the component stereo, or input the same by means of a given reservation code indicated in the program list, or the like, and therefore the setting takes a lot of trouble.

### DISCLOSURE OF THE INVENTION

An object of the present invention is to provide a system and an apparatus for encouraging viewing broadcast contents, which can solve the above described problem.

A system for encouraging viewing according to claim 1, which has been devised to solve the above problem, comprises: an e-mail transmission side apparatus for transmitting e-mail including obtaining information for obtaining a broadcast date and time and a broadcast channel and an e-mail receiving side system for receiving the e-mail and outputting the content of the e-mail to a user.

The e-mail receiving side system receives e-mail transmitted from the e-mail transmission side apparatus and obtains the broadcast date and time and the broadcast channel in accordance with the obtaining information. When a recording instruction of the broadcast content is inputted by the user in accordance with the e-mail, at least either a recording reservation command to make a recording reservation of the broadcast content with the obtained broadcast date and time and the broadcast channel or a recording command to record the broadcast content with the obtained broadcast channel when the obtained broadcast date and time has passed, and the broadcast content is received and recorded in accordance with the outputted recording reservation command or recording command.

Recording means may be, for example, a VCR equipped with a TV tuner or a component stereo equipped with a radio tuner. Specifically, it may receive the content of TV broadcast and record the images and sound as a VCR, or may receive the content of radio broadcast and record the sound as a stereo. That is, “recording” includes image recording and sound recording. This is applicable to the after-mentioned claim 2 or 3.

A recording medium for recording the broadcast content for the VCR or the component stereo may be one in any form, such as a tape, an optical disk, a hard disk or a semiconductor device. Accordingly, the recording means includes, for example, a video tape recorder, a video disk recorder, a cassette recorder, a mini disk recorder, an IC recorder and a personal computer.

Respective means should be constituted, for example, as the following (1) through (4).

The matters described in (1) through (4) are applicable to after-mentioned claims 2 through 14.

(1) Instruction input means should function, for example, by clicking a certain point, such as a button or a link, in the e-mail. Thus, quite easy recording is accomplished by a simple click on the certain point.

(2) The obtaining information may be the information itself of the broadcast date and time and the broadcast channel (referred to as the broadcast information), or the information for obtaining the broadcast information, such as the URL of the site on which the broadcast information can be obtained. When the broadcast information is included in the e-mail as the obtaining information, broadcast information obtaining means can obtain the broadcast information from the e-mail. Accordingly, it is unnecessary to obtain the broadcast information through a network or the like. Alternatively, broadcast information obtaining means may be designed to obtain the broadcast information through a network, which enables constant obtainment of the latest broadcast information. Broadcast information obtaining means may obtain the broadcast date and time and the broadcast channel when the recording instruction is inputted by the instruction input means, or before the recording instruction is inputted by the instruction input means.

(3) The information of the broadcast date and time, which includes at least the broadcast start date and time, preferably includes the broadcast finish date and time. The information of the broadcast channel may include whether the broadcast is by ground wave, broadcasting satellite (BS) or communication satellite (CS).

According to the above system, when e-mail including “Next Week's Recommended Programs” along with the obtaining information is transmitted, a viewer can receive the e-mail, select a desired program from “Next Week's Recommended Programs,” and make a recording reservation just by clicking the recording button of the program. It is, therefore, possible to easily record the desired broadcast content without inputting the information about the broadcast date and time and the channel as well as a reservation code and the like through a recording apparatus such as a VCR or its remote controller.

This facilitates a simple recording reservation process, which encourages people who have given up recording programs because of a troublesome recording reservation process to view programs.

Since viewing of the broadcast content is encouraged by the simple recording reservation process, the number of viewing a broadcasted commercial and the number of viewers will increase. Accordingly, a user can be more familiar with the features of the object of the commercial by viewing the commercial more frequently. Viewing images and sound via broadcasts enables the viewer to view the images and sound of a desired commercial easily, without, for example, taking time to download the data of the commercial through the Internet.

An increase in the viewer rating of the commercial enhances the advertisement effects of the commercial by the commercial offerer (advertiser), which may lead the sales to increase and the broadcast station to gain increased income. While an article for sale, whose features users cannot be well informed of without images or sound, has been advertised by sending video data or sound data to the users as well as the sentences and images on the Internet homepage, the video data or the sound data take a substantial time to be transferred and, therefore, is mostly difficult to transmit through the Internet. However, it is possible to inform the users of the features and the like of the article for sale with no need of downloading the images and the sound of the commercial through the Internet according to the present invention. For example, if the e-mail includes the information about the program or the commercial as well as the link to the homepage of the program or the link to the commercial offerer, the user can learn about the program information, the object item of the commercial, the company as the advertiser, etc., which encourages the user to have more interest in the program or the commercial.

Furthermore, the e-mail should include, along with the message that the commercial will be broadcasted, contents which motivate the user to view the commercial, such as the object item of the commercial and the name of the advertiser of the commercial, the content of the commercial, the names of the commercial performers, the title of the music in the commercial and the names of the music performers. It may also include the content to inform about the broadcast time of the commercial or the content concerning the program during which the commercial is broadcasted. These will enhance the possibility of the user inputting a recording instruction.

Therefore, claim 2 is presented to further encourage viewing of a commercial. The system for encouraging viewing as set forth in claim 2 comprises: an e-mail transmission side apparatus for transmitting e-mail including a message that a commercial will be broadcasted and obtaining information for obtaining the broadcast date and time and the broadcast channel of the commercial or the program during which the commercial is broadcasted and an e-mail receiving side system for receiving the e-mail. The e-mail receiving side system receives the e-mail transmitted from the e-mail transmission side apparatus and output the content of the e-mail to the user. It also obtains the broadcast date and time and the broadcast channel in accordance with the obtaining information included in the e-mail. When a recording instruction by the user is inputted in accordance with the e-mail, at least either a recording reservation command to make a recording reservation of the broadcast content with the broadcast date and time and the broadcast channel or a recording command to record the broadcast content with the broadcast channel when the broadcast date and time has passed, and receives and records the program or the commercial in accordance with the outputted recording reservation command or recording command.

Thus, receiving and recording commercials via TV broadcast or receiving and recording commercials via radio broadcast, for example, is facilitated. Also, the user can learn in advance that a commercial will be broadcasted when receiving and viewing the e-mail. If the user gets interested in the commercial referred to in the e-mail, the user can easily record the commercial or the program during which the commercial is broadcasted without inputting the information about the broadcast date and time and the channel or a reservation code or the like by inputting a recording instruction. Therefore, the above described effect of “encouraging viewing of commercials” by the system as set forth in claim 1 can be further enhanced and ensured as well.

In the case where the broadcast time of the commercial is fixed, recording may be performed at that time. In the case where the broadcast time of the commercial is not fixed, only the commercial part of the broadcast content may be recorded as set forth in claim 3. This is performed by determining whether the content on air is a program or a commercial, and recording the commercial. The determination may be based on, for example, the information by an electronic program guide or the like indicating that the commercial is on, the information about, for example, whether the sound is in stereo or monaural, or the sponsor code which is a unique code for each sponsor and is encoded in the content of the commercial.

Besides recording the broadcast content as above, encouraging users to view the broadcast content in the manner as set forth in claim 4 or 5 may be possible.

A system for encouraging viewing commercials comprises an e-mail transmission side apparatus for transmitting e-mail including obtaining information for obtaining broadcast date and time and a broadcast channel and an e-mail receiving side system for receiving the e-mail and outputting the content of the e-mail to a user. The e-mail receiving side system receives e-mail and obtains the broadcast date and time and the broadcast channel in accordance with the obtaining information. When an output instruction of the broadcast content is inputted by the user in accordance with the e-mail, at least either an output reservation command to make an output reservation of the broadcast content with the obtained broadcast date and time and the broadcast channel or an output command to output the broadcast content with the broadcast channel when the obtained broadcast date and time has passed is outputted, then receives the broadcast content in accordance with the output reservation command or the output command and output the broadcast content. Examples of output means are a TV and a radio. That is, it may be a TV which receives the broadcast contents of TV broadcast and outputs images and sound, or a radio which receives the broadcast contents of radio broadcast and outputs sound. This is applicable to the cases of after-mentioned claims.

According to this system, the TV or the radio is turned on and set to the broadcast channel automatically at the broadcast date and time. Thus, the possibility of missing or missing hearing the broadcast content can be reduced.

A system for encouraging viewing commercials as set forth in claim 5 comprises an e-mail transmission side apparatus for transmitting e-mail including a message that a commercial will be broadcasted and obtaining information for obtaining the broadcast date and time and the broadcast channel of the commercial or the program during which the commercial is broadcasted and an e-mail receiving side system for receiving the e-mail, and the e-mail receiving side system receives the e-mail transmitted from the e-mail transmission side apparatus and outputs the content of the e-mail to a user. The e-mail receiving side system also obtains the broadcast date and time and the broadcast channel in accordance with the obtaining information included in the e-mail. When an output instruction of the program or the commercial is inputted by the user in accordance with the e-mail, at least either an output reservation command to make an output reservation of the broadcast content with the broadcast date and time and the broadcast channel, or an output command to output the broadcast content with the broadcast channel when the broadcast date and time has passed is outputted, and the program or the commercial is received in accordance with the outputted output reservation command or output command, then is outputted.

According to this system, when the user receives and reads the e-mail, for example, the user can learn that the commercial will be broadcasted. Also, if the user gets interested in the object item of the commercial or the program indicated in the e-mail, the user only needs to input an output instruction in accordance with the e-mail to make a TV or a radio turned on at the broadcast date and time and set to the broadcast channel of the program or the commercial automatically. Thus, the possibility of missing the program or the commercial can be reduced. That is, the user can easily view the commercial or the program during which the commercial is broadcasted. As a result, viewing of programs or commercials may be encouraged.

While viewing of programs or commercials may be encouraged by any system in claims 1 though 5 as described above, a system according to claim 6 may also be employed. Specifically, points are to be awarded when a recording instruction or an output instruction is inputted by a user. This encourages the user to input a recording instruction or an output instruction in order to obtain points, which results in a higher possibility of viewing programs or commercials. Thus, broadcast stations can enhance the possibility of their programs being viewed and the advertiser and the like can further enhance the advertisement effects of their commercials.

Point, which is a beneficial thing to users, may be an abstract figure or a figure indicating a specific object, such as amount of money or mileage. Examples of objects for pointing are the right to buy goods, cash, a coupon for goods, an air ticket, the right to view a pay-per-view program, the right to use an Internet pay-per-view site, the right to use telephone for free, discount coupon, etc. It is possible to award users points and to provide the above-mentioned right to buy goods, cash, coupon for goods, air ticket, the right to view a pay-per-view program, the right to use an Internet pay-per-view site, the right to use the telephone for free, a discount coupon, etc. only when the points reach a certain value. It is also possible to associate the points with respective amounts of money and pay the money to the user's account or provide the money in the form of electronic money usable through a network every predetermined time period or every time a predetermined point is reached.

Respective means in the e-mail receiving side systems constituting systems for encouraging viewing as set forth in claims 1 through 6 may be discretionarily combined to supply an apparatus. For example, an apparatus for encouraging viewing may comprise e-mail receiving means, instruction input means, broadcast information obtaining means and recording control means as set forth in claim 7. According to this, a recording reservation command or a recording command is outputted to a recording apparatus, with the result that the effect shown in claim 1 can be obtained. Similarly, if an apparatus for encouraging viewing as set forth in claim 8 is employed, the effect shown in claim 2 can be obtained. If an apparatus for encouraging viewing as set forth in claim 9 is employed, an output reservation instruction or an output instruction is outputted to an output apparatus, with the result that the effect shown in claim 4 can be obtained. If an apparatus for encouraging viewing commercials as set forth in claim 10 is employed, the effect shown in claim 5 can be obtained.

It may be possible, as set forth in claim 11, to receive data including obtaining information and determination information for determining whether or not the broadcast content should be recorded, to determine whether to record the broadcast content in accordance with the determination information, and to output, if determined to record by determining means, a recording reservation command or a recording command. For example, if the data receiving means receives the recording reservation command in claim 7 as the data in claim 11, a recording reservation command for making a recording reservation of the broadcast content in accordance with the received recording reservation command or a recording command is outputted. That is, in accordance with an instruction from, for example, another apparatus for encouraging viewing or an instruction from a data transmitting apparatus for transmitting data including obtaining information and determination information, a recording reservation can be made without an input of the instruction by the user. Such an apparatus enables the user to make a recording reservation on the recording apparatus at home in accordance with, for example, the instruction outside the home. Therefore, viewing can be further encouraged.

Furthermore, according to a system for encouraging viewing as set forth in claim 12, it is determined whether to record the broadcast content or not in accordance with the determination information included in the broadcast content, and, if determined to record, a recording command to record the broadcast content is outputted to the recording apparatus. Accordingly, a recording command is outputted regardless of the user's intent whenever recording is determined. For example, when a sponsor code, which is a unique code for each sponsor and encoded in the commercial content, is used as the determination information, it is possible to output a recording instruction to forcibly record only the commercials with the sponsor code for a specific sponsor. Therefore, the sponsor may have the content of its own commercials more surely recorded, thereby encourage viewing further.

Meanwhile, the broadcast content recorded by the recording means as set forth in claims 1 to 3 may be outputted as indicated in claim 13. That is, when the user inputs an output instruction of the recorded broadcast content based on the e-mail, the receiving side system outputs an output instruction of the broadcast content, thereby outputs (reproduces) the broadcast content recorded by the recording means. This enables the user to easily outputs the recorded broadcast content.

Also as indicated in claim 14, it may be possible to receive the broadcast and record the broadcast content as needed, then output (reproduce) the broadcast content when the user inputs an output instruction of the recorded broadcast content based on the e-mail. This enables the user to view the desired program after the broadcast starts without any trouble in making a recording reservation.

As indicated in claim 15, the function to realize e-mail receiving means, instruction input means, broadcast information obtaining means, recording control means, recording means, output control means, output means in a computer system may be provided, for example, as a program which starts on the computer system side. Such a program may be recorded on a computer-readable recording medium, such as a floppy disk, a magnetooptic disk, a CD-ROM, a hard disk, a ROM or a RAM, and used by loading it into the computer system and running it if required. Alternatively it may be used by loading it via the Internet and running it.

### BRIEF DESCRIPTION OF THE DRAWINGS

FIG. 1 is a block diagram showing the constitution of a system for encouraging viewing according to a first embodiment;

FIG. 2 is an explanatory view showing the content of mail received by a mail receiving terminal;

FIG. 3 are flow charts showing the recording reservation processing executed by the mail receiving terminal;

FIG. 4 is a flow chart showing the processing to control TV for viewing a program executed by the mail receiving terminal;

FIG. 5 is a block diagram showing the constitution of a system for encouraging viewing according to a second embodiment;

FIG. 6 is a block diagram showing the constitution of a system for encouraging viewing according to a third embodiment;

FIG. 7 are diagrams showing the constitution and an example of display indication of a system for encouraging viewing according to a fourth embodiment; and

FIG. 8 is a block diagram showing the constitution of a system for encouraging viewing according to a fifth embodiment.

### BEST MODE FOR CARRYING OUT THE INVENTION

Embodiments to which the present invention is applied will be explained with the aid of the drawings. It is needless to say that the present invention should not be limited to the embodiments below, but may be embodied in various forms within the technical scope of the present invention.

First Embodiment

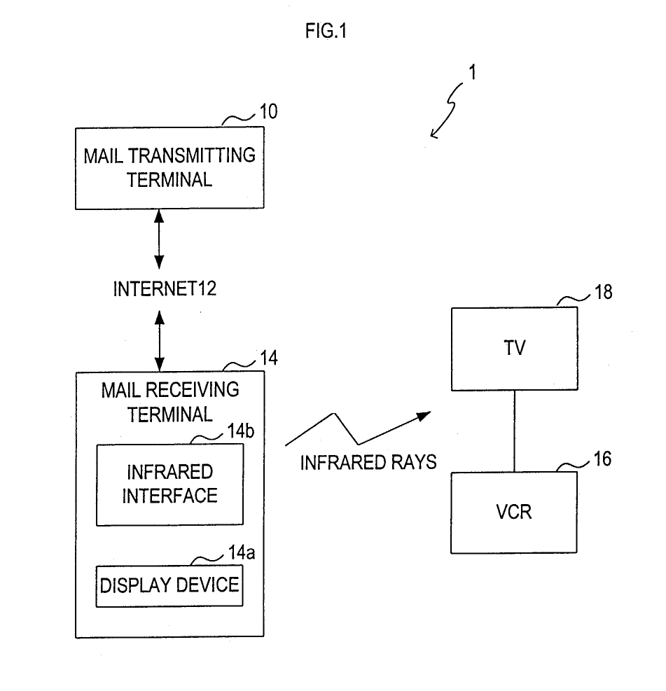

As shown in FIG. 1, a system for encouraging viewing 1 according to the present embodiment comprises a mail transmitting terminal 10, the Internet 12, a mail receiving terminal 14, a VCR 16 and a TV 18. The VCR 16 is a typical VCR which works by remote control and it is possible to set the recording start date and time, the recording finish date and time, the channel to be recorded, etc. on the VCR by means of a not shown remote controller. The TV 18 also is a typical TV which works by remote control and it is possible to, for example, turn on/off the power and set the channel by means of a not shown remote controller. The VCR 16 and the TV 18 are connected via an image signal line, and the image outputted by the VCR 16 can be displayed by the TV 18. The mail transmitting terminal 10 is a typical computer, which is connected to the Internet. The mail receiving terminal 14 is a notebook computer provided with a display device 14a and an infrared interface 14b, which is connected to the Internet 12. The infrared interface 14b is capable of outputting a signal the same as the setting signal outputted by means of infrared radiation from the respective remote controllers of the VCR 16 and the TV 18.

The mail transmitting terminal 10 and the mail receiving terminal 14, in both of which mailing software (hereinafter referred to as mailer) is installed, are capable of transmitting or receiving mail, respectively, through the Internet 12.

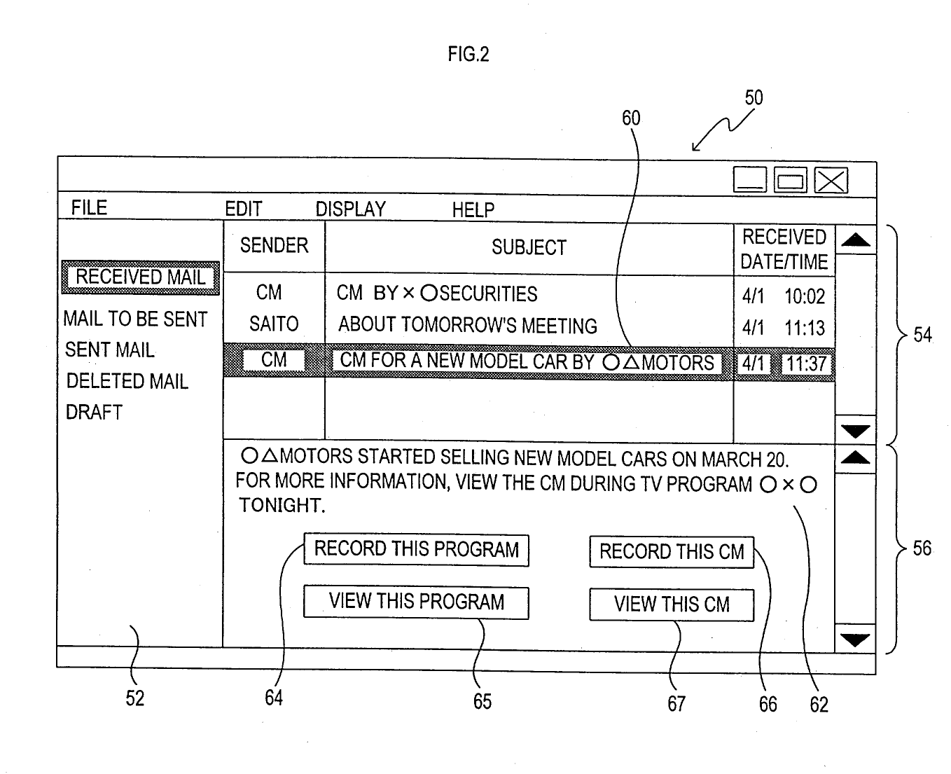

An advertiser sends, from the mail transmitting terminal, e-mail including the message that a commercial (hereinafter also referred to as a CM) by the advertiser will be TV broadcasted to the mail server managing the mail address of an intended mail recipient. The mail in HTML format includes the information about the program start date and time, the program finish date and time, the CM start date and time, the CM finish date and time, the broadcast channel in the comment tag. The mail recipient receives the mail from the mail server. FIG. 2 shows an example of how the received mail is displayed on the display device 14a of the mail receiving terminal 14.

A mailer screen 50 in FIG. 2 comprises a folder selecting field 52, a title display field 54, and a mail content display field 56. Then folder selecting field 52 is the field for selecting a folder to store mail out of the folders corresponding to received mail, mail to be sent, sent mail, deleted mail and draft mail, respectively. In FIG. 2, received mail is selected (selected part is highlighted). Accordingly, a title list of the received mail is displayed in the title display field.

Titles, including the sender, the subject and the received date and time, are displayed in the title display field 54. In the example of FIG. 2, the titles of three pieces of mail are displayed in the order of received date and time in the title display field 54. When the mail recipient selects a title corresponding to the content to view from the title list and clicks on the title, the content of the mail with the title is displayed in the mail content display field 56.

In FIG. 2, one piece of mail having the subject “CM for a new model car by ◯ΔMotors” sent from ◯ΔMotors as the advertiser is selected. The content of the selected mail 60 is displayed in the mail content display field 56. This mail includes the above-mentioned message that “a CM by the advertiser will be TV broadcasted” or more specifically “◯ΔMotors started selling new model cars on March 20. For more information, view the CM during TV program ◯×◯ tonight.”Below the message are arranged a program record button 64 indicating “Record this Program,” a program view button 65 indicating “View this Program,” a CM record button 66 indicating “Record this CM” and a CM view button 67 indicating “View this CM.”

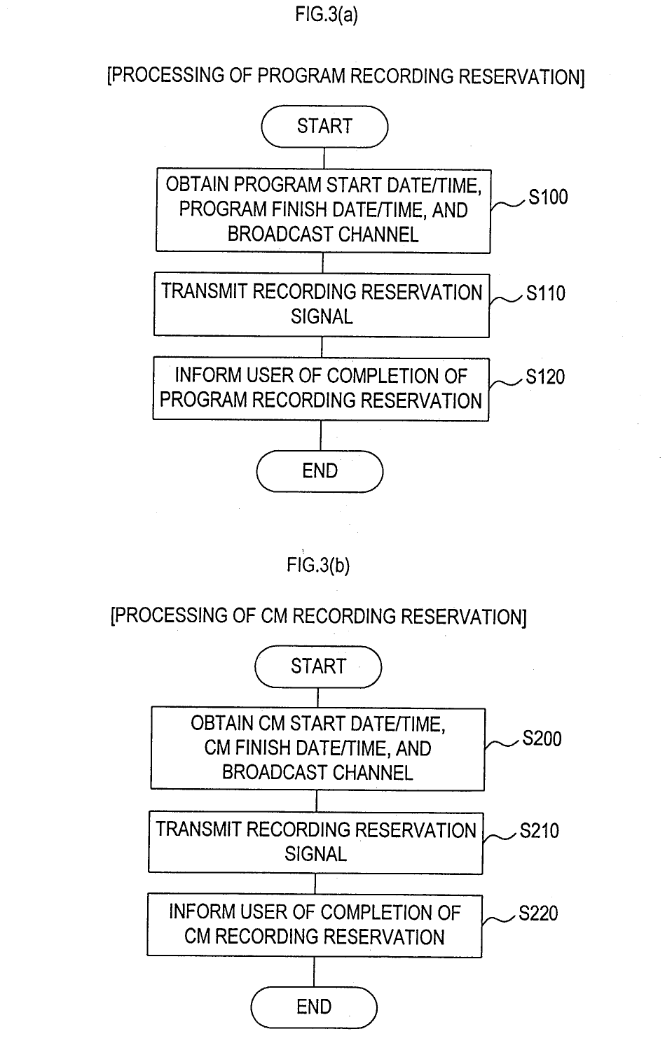

When the program record button 64 is clicked by a user such as a mail recipient, the mail receiving terminal 14 performs the processing of program recording reservation as shown in FIG. 3(a).

In the processing of program recording reservation, firstly, the program start date and time, the program finish date and time, and the broadcast channel included in the comment tag are obtained at S100. Secondly, at S110, a recording reservation signal containing the recording start date and time, the recording finish date and time, and the channel to be recorded corresponding, respectively, to the program start date and time, the program finish date and time, and the broadcast channel obtained at S100 is sent from the infrared interface 14b, thereby to complete setting of a recording reservation on the VCR 16. Then at S120, a message is displayed on the display device 14a to inform the user that the program recording reservation has been completed.

As described above, the user can make a recording reservation of “TV program ◯×◯” indicated in the mail by merely clicking the program record button 64 within the mail. Therefore, when the user wants to record the TV program indicated in the mail, a recording reservation may be substantially easily made without performing setting of the recording reservation using, for example, a remote controller for a VCR. In turn, “◯ΔMotors” or the advertiser can obtain an increased CM viewers because the user views the program recorded with the VCR 16 as above.

On the other hand, when the CM record button 66 in FIG. 2 is clicked, the processing of CM recording reservation shown in FIG. 3(b) is performed. In the processing of CM recording reservation, which is substantially the same as the processing of program recording reservation, the CM start date and time, the CM finish date and time, and the broadcast channel included in the tag of the mail are obtained at S200 shown in FIG. 3(b). Subsequently, at S210, a recording reservation signal containing the recording start date and time, the recording finish date and time, and the channel to be recorded corresponding, respectively, to the CM start date and time, the CM finish date and time, and the broadcast channel obtained at S200 are sent from the infrared interface 14b, thereby to complete setting of a recording reservation on the VCR 16. Then at S220, a message is displayed on the display device 14a to inform the user that the CM recording reservation has been completed.

As described above, the user can complete the recording reservation of the CM for a new model car released by ◯ΔMotors on March 20 indicated in the mail by merely clicking the CM record button 66 within the mail. Therefore, it is easy for the user to perform setting of the recording reservation when the user is interested in an item or the like indicated in the mail and wants to view the CM. In turn, “◯ΔMotors” or the advertiser can achieve a higher viewer rating because the user views the CM which has been recorded with the VCR 16 as above.

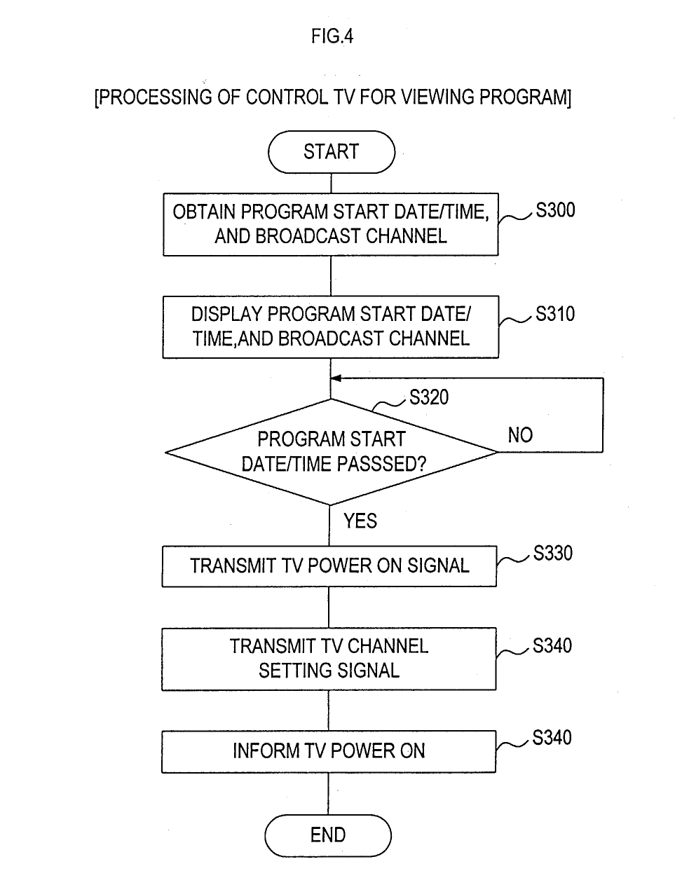

When the program view button 65 in FIG. 2 is clicked by the user, the processing to control TV for program viewing is performed as shown in FIG. 4.

At S300, the program start date and time and the broadcast channel included in the comment tag of the mail are obtained. Subsequently at S310, the program start date and time and the broadcast channel are displayed on the display device 14a to be notified to the user. This is to invite the user's attention so as to prevent the user from turning off the power of the mail receiving terminal 14 and thereby becoming unable to control TV. Then, at S320, the current date and time is obtained from the timer of the mail receiving terminal 14 and it is determined whether or not the program start time has passed. If the program start time has not passed (S320: NO), S320 is repeatedly executed. If the current date and time has reached the program start date and time (S320: YES), the processing goes on to S330. At S330, a power-on signal for the TV 18 is transmitted from the infrared interface 14b. Then at S340, a channel setting signal for setting the broadcast channel as the channel to be outputted on the TV 18 is transmitted from the infrared interface 14b. At S350, a message that the TV 18 has been powered on is displayed on the display device 14a to notify the user of it.

According to the above, when the user clicks on the program view button 65, the TV is automatically powered on at the program start time and its channel is set to the intended program broadcast channel. Therefore, the possibility of missing the program can be reduced. Especially when using the mail receiving terminal 14 for various works such as reading mail, the user sometimes miss a program which he/she wants to view. However, according to the present system 1, it will not happen because the user is notified that the TV 18 has been powered on. Further, the advertiser can increase the possibility of the CM being viewed.

When the CM view button 67 in FIG. 2 is clicked by the user, the processing to control TV for CM viewing, which is substantially the same as the processing to control TV for program viewing when the program view button 65 is clicked, is performed. By replacing “the program start date and time” in the processing to control TV for program viewing shown in FIG. 4 with “the CM start date and time,” the processing to control TV for CM viewing is obtained. Accordingly, the TV 18 is automatically powered on at the CM start time and set to the channel in which the CM is broadcasted, and the user is prevented from missing the CM. Also, the advertiser can increase the possibility of the CM being viewed.

Although the mail receiving terminal 14 is a notebook computer in the present embodiment, it may be any device capable of receiving mail, such as another kind of personal computer, a PDA, a set-top box, a game machine, a mobile phone, or other electronic products. The infrared interface 14b may be housed in these mail receiving terminals or may be external. It is also possible to use other means instead of using infrared as long as the VCR or the TV can be controlled with the means. For example, radio control or wire control may be employed as well as the control via communication lines such as a telephone line or a pager line. Furthermore, the function of the mail receiving terminal may be equipped in the TV or the VCR. In this case, the TV or the VCR can be controlled directly without involving the infrared interface 14b and the like.

If the TV allows setting of the date and time of power on from the outside, a viewing reservation signal for setting the date and time of power on and the channel may be transmitted in substantially the same manner as in the processing of recording reservation shown in FIG. 3. On the contrary, with respect to the VCR, it is possible to send a recording signal at the program start date and time to perform recording in the same manner as in the case of the TV in FIG. 4. In this case, the processing of turning on the power of the VCR, setting the channel and transmitting the recording signal to start recording and the processing to notify the start of recording is performed instead of the processing at S330 to S350.

Although the TV and the VCR are controlled in the present embodiment, a radio and a component stereo set and the like may also be controlled. In such a case, audio programs and CM's can be viewed and recorded.

The TV or the radio preferably has the function of image recording or sound recording CM parts only. In this case, even when the CM broadcast date and time are unknown, only the CM can be recorded as long as the broadcast date and time for the program during which the CM is broadcasted is known.

Although mail in HTML format is employed in the present embodiment, mail in text format may also be employed. In such a case, for example, links to each program for executing each are to be contained, and the processing is performed when the link is clicked.

The program start date and time, the program finish date and time, the CM start date and time, the CM finish date and time, and the broadcast channel, which are included in the comment tag and the recording reservation of a program or the like is performed after obtaining such information, need not always be included in the comment tag. For example, a tag indicating a recording reservation may be defined and included in the mail along with the information about, for example, the program start date and time, the program finish date and time, and the broadcast channel, etc. as a link to the program. In this case, such information will be obtained by analyzing the defined tag. Alternatively, the program start date and time, the program finish date and time, the CM start date and time, the CM finish date and time, and the broadcast channel may be included in such a manner that the user can view the same. In the processing of recordation reservation of the program, setting may be performed based on such included information. In this case, the above information is also indicated in the mail shown in FIG. 2, and thus the user may learn exactly when the program or the like will be broadcasted.

Although the program start date and time, the program finish date and time, the CM start date and time, the CM finish date and time, and the broadcast channel are included in the mail sent from the mail transmitting terminal 10 in the present embodiment, it is possible not to include the information in the mail but to obtain the information by connecting to a program information site having the information when respective buttons 64 to 67 in FIG. 2 are clicked. Specifically, obtaining the program start date and time, the program finish date and time, and the broadcast channel at S100 in the processing of program recording reservation in FIG. 3(a) or obtaining the CM start date and time, the CM finish date and time, and the broadcast channel at S200 in the processing of program recording reservation in FIG. 3(b) or obtaining the program start date and time and the broadcast channel at S300 of the processing to control TV for program viewing, or obtaining the CM start date and time, and the broadcast channel in the processing to control TV for CM viewing may be performed by connecting to the program information site. In this case, the latest information about the broadcast date and time and the like can be always obtained.

Furthermore, points may be awarded to the user on the program information site when the user connects to the program information site and obtains the information, such as the broadcast date and time. This leads the user to view or record more programs in order to earn points. Therefore, viewing of programs and CM's is further encouraged.

Point here means something corresponding to a beneficial thing to users, and may be an abstract figure or a specific figure, such as amount of money or mileage. Examples of objects for pointing are the right to buy goods, cash, a coupon for goods, an air ticket, the right to view a pay-per-view program, the right to use an Internet pay-per-view site, the right to use telephone for free, a discount coupon, etc. Also it is possible to award users points and to provide the above-mentioned right to buy goods, cash, a coupon for goods, an air ticket, the right to view a pay-per-view program, the right to use an Internet pay-per-view site, the right to use telephone for free, a discount coupon, etc. only when the points reach a certain value. Also it is possible to associate the points with respective amounts of money and pay the money to the user's account or provide the money in the form of electronic money usable through a network every predetermined time period or every time a predetermined point is reached. For example, awarded points such as ¥1 or ¥3 may be directly usable as cash, or may not be usable as a privilege until the points reach a certain value such as ¥500 or ¥1000. In this case, it is preferable to inform the user that his/her points have reached a certain value, or to inform the user of his/her current points every predetermined time period by e-mail or the like. This enables the user to know how many additional points, i.e. how much more recording and the like, are necessary to get the privilege, and therefore the user aims to earn the additional points, which encourages further viewing by the user.

Points to be awarded may be different depending on each program or CM. This encourages the user to record or view such programs or CM's that the user can earn more points thereby. Accordingly, in the case of news programs, for example, during which almost the same contents are broadcasted in all channels, the user is more likely to record or view a program with higher points, which leads to differentiation between one channel and the others.

When points are unconditionally awarded per clicking, the following disadvantage will be caused. If one user makes recording reservations for the same program repeatedly, points are awarded for each reservation and the advertiser must pay the expenses for all the points. It means that the advertiser will be charged money corresponding to the points without any advertisement effect except for the first or the second time reservation.

To avoid the above disadvantage, points are not awarded to the same recording instruction or output instruction by the same user. That is, the user can earn points only at the first time and none at the others.

When sending e-mail, the mail transmitting terminal 10 may transmit, for example, the same content to a plurality of users' mail addresses registered in a database. Alternatively, e-mail may be sent after determining the relation between the contents to be transmitted and the e-mail addresses by considering the user information inputted by respective users via forms on the home page or e-mail. The user information includes attributes, such as each user's address, name, age, occupation, telephone number, sex, annual income, e-mail address, hobby, interest types, etc. Transmission after considering the user information and determining the relation between the information to be transmitted and the e-mail addresses enables providing information about programs and CM's which are suitable to the user's attributes. It may be possible, for example, to consider the user's hobby and provide information about the programs and CM's related to the hobby, or to consider the user's occupation and provide information about the programs and CM's related to business. It may also be possible to provide information about CM's for goods or services suitable to the income or the age, or about CM's for shops near the user's address. Furthermore, it may be possible to indirectly obtain information from the information, such as the e-mail address or the telephone number determined in accordance with certain rules, then decide the e-mail addresses to which the information is to be transmitted. In the case of telephone number, the area where the user lives may be identified from, for example, the telephone exchange number. In the case of e-mail address, information about the area where the user lives and the affiliation, i.e. from which of an educational institution, a company, a government agency or a provider the access is, etc. may be obtained.

By determining the relation between the contents to be transmitted and the intended e-mail addresses considering the user information, each advertiser can effectively make a CM for an item viewed by target viewers. In turn, users can efficiently view the programs and CM's in the fields in which they are interested.

In the present embodiment, the mail transmitting terminal 10 corresponds to an e-mail transmission side apparatus and the mail receiving terminal 14 corresponds to an apparatus for encouraging viewing. The mail receiving terminal 14, the TV 18 and the VCR 16 correspond to an e-mail receiving side system. The mailer of the mail receiving terminal 14 corresponds to e-mail receiving means. The program record button 64, the CM record button 66, the program view button 65, the CM view button 67 and a not-shown mouse for clicking correspond to instruction input means. The processing at S100, S200 and S300 corresponds to the processing as broadcast information obtaining means. Further, the mail receiving terminal 14, including the infrared interface 14b, and the processing at S110 and S210 correspond to the processing as recording control means, and the VCR 16 corresponds to recording means. The mail receiving terminal 14, including the infrared interface 14b corresponds to viewing control means, and the processing at S320 through S340 corresponds to the processing as output control means. The TV 18 corresponds to output means and the program information site corresponds to point rewarding means. The program start date and time, the program finish date and time, the CM start date and time, and the CM finish date and time correspond to the broadcast date and time. The recording reservation signal corresponds to recording reservation command, and the recording signal corresponds to a recording command. The viewing reservation signal corresponds to an output reservation command, and the power-on signal and the channel setting signal correspond to an output command.

Second Embodiment

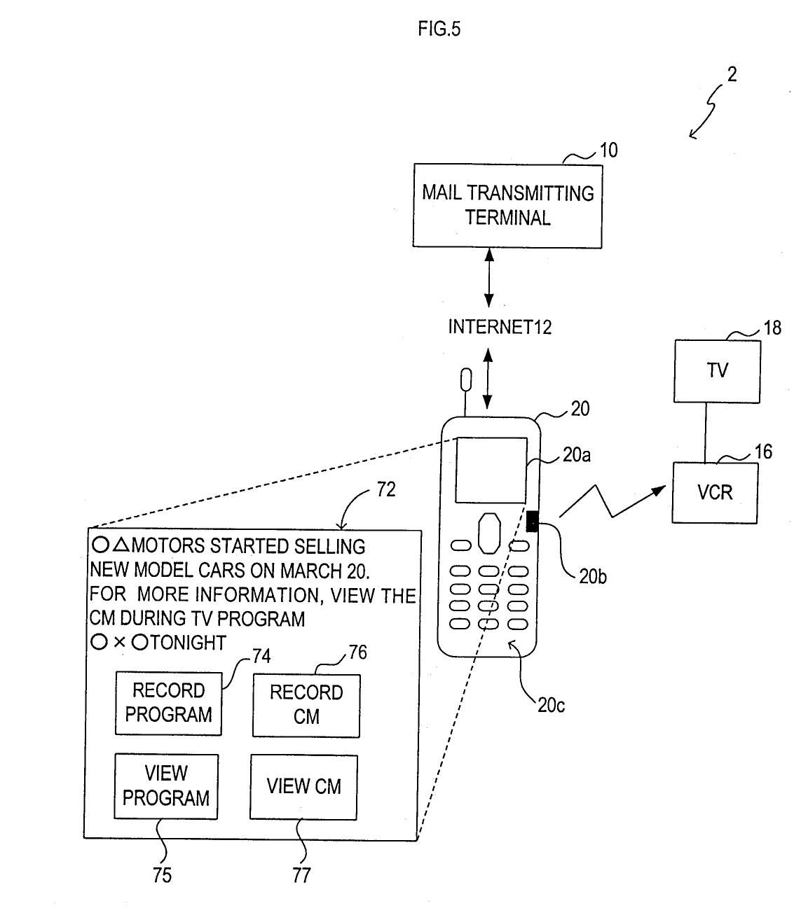

While the mail receiving terminal is a notebook computer in the first embodiment, it may be, for example, a mobile phone having Internet access and an infrared interface. This example will be explained with reference to FIG. 5.

FIG. 5 shows a system for encouraging viewing 2 constituted using a mobile phone 20 as an apparatus for encouraging viewing. The mobile phone 20, which is a common mobile phone device with the Internet communication function (e-mail function as e-mail receiving means and the WWW browser function) provided with a keyboard 20c as instruction input means and a display device 20a, can send information inputted through the key board 20c to the Internet 12, receive information from the Internet 12 and display the same on the display device 20a. Further provided is an infrared interface 20b, which plays the same role as the infrared interface 14b in the first embodiment. More particularly, by the control of the CPU inside the mobile phone 20, it is possible to output the same signal as the signal outputted via infrared rays from the respective remote controllers for the VCR 16 and the TV 18. Since the constitution except for the mobile phone 20 is the same as in the first embodiment, further explanation is omitted.

The enlarged view of the display device 20a of the mobile phone 20 in FIG. 5 shows an example of mail transmitted from the mail transmitting terminal 10 and received by the e-mail receiving function. The content of the mail, which is substantially the same as the content in the mail content display field 56 in the first embodiment as shown in FIG. 2, includes a mail body 72 of “◯ΔMotors started selling new model cars on March 20. For more information, view the CM during TV program ◯×◯tonight.” which is the same as the mail body 62 (see FIG. 2) in the first embodiment. Below the message are provided a program record button 74 indicating “Record Program,” a program view button 75 indicating “View Program,” a CM record button 76 indicating “Record CM” and a CM view button 77 indicating “View CM.” When one of these buttons is selected, the processing corresponding respectively to the cases of the program record button 64, the program view button 65, the CM record button 66 and the CM view button 67 shown in FIG. 2 in the first embodiment.

Such a constitution enables a user having the mobile phone 20 with him/her and keeping the phone active to obtain information about programs and CM's any time and anywhere. The mobile phone 20, which is generally used with its power always on to stand by for arrival of mail, enables further secure control of the VCR 16 and the TV 18.

If the VCR 16 and the TV 18 are provided with a function controllable by wireless means other than infrared rays, a wireless communication apparatus capable of communicating with the VCR 16 and the TV 18 should be provided instead of the infrared interface 20b.

Third Embodiment

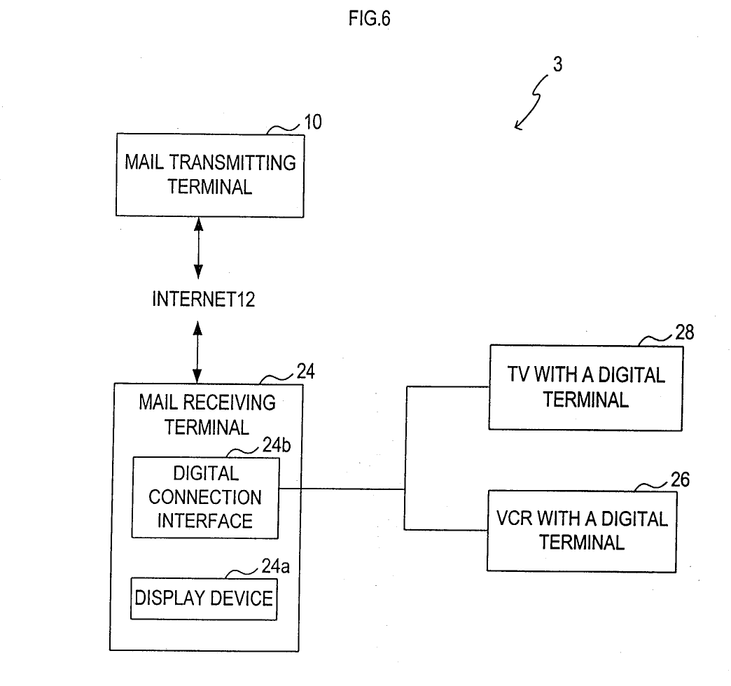

While the first embodiment and the second embodiment have a constitution in which the VCR and the TV are controlled by wireless means, such as infrared rays, a system for encouraging viewing 3 controlled via fixed lines as shown in FIG. 6 may be possible. Specifically, instead of the TV 18 and the VCR 16 in the first embodiment, a TV with a digital terminal 28 as output means and a VCR with a digital terminal 26 as recording means are employed. Also, a mail receiving terminal 24 having a built-in digital connection interface 24b is used instead of the mail receiving terminal 14, and these three apparatuses are connected and controlled via cables instead of infrared rays. The processing and the indications on the display device are substantially the same as in the first embodiment, and the processing to output a signal from the infrared interface 14b in the first embodiment is replaced by the processing to output a signal from the digital connection interface 24b.

IEEE 1394, for example, is used as the digital connection standard. Metal cables or optical cables may be used for connecting the apparatuses. HAVi (Home Audio Video interoperability) may be used as the control protocol.

While the mail receiving terminal 24 is provided with the display device 24a in FIG. 6, the mail receiving terminal 24 need not always have the display device 24a. In this case, it is possible to transmit the screen images of the content of mail in a digital signal to the TV with a digital terminal 28 via the digital connection interface 24b. Transmission of an image signal between the VCR with a digital terminal 26 and the TV with a digital terminal 28 may be performed via digital terminals.

Fourth Embodiment

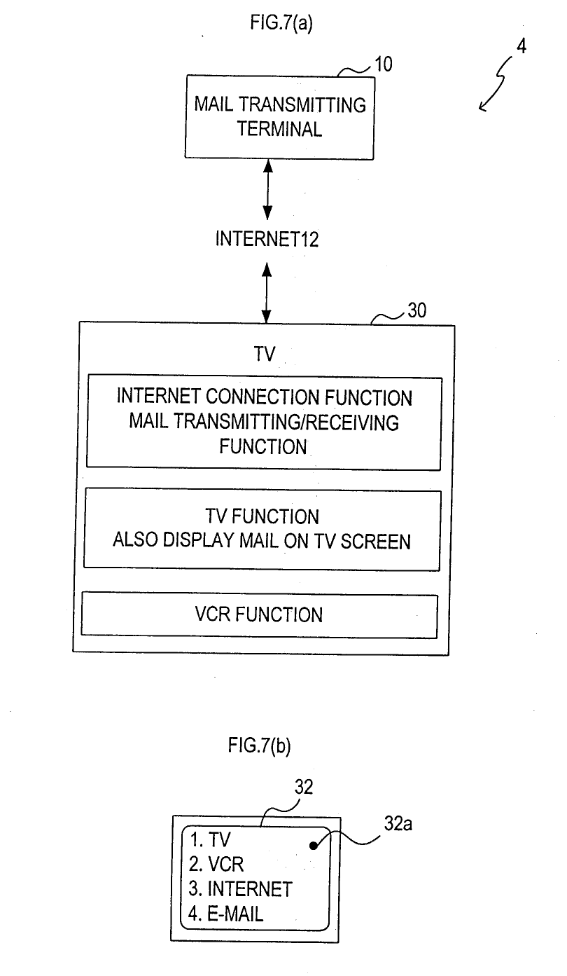

The receiving side system, which consists of a plurality of apparatuses in the first embodiment through the third embodiment, may be an integrated apparatus such as a multifunction TV 30 provided with Internet connection function (e-mail function, WWW client function, etc.) and recording function, as in a system for encouraging viewing 4 shown in FIG. 7(a).

The multifunction TV 30 displays a menu shown in FIG. 7(b) on a display device 32 when the power is turned on or an instruction by a not shown remote controller is given. The menu includes “1. TV”, “2. VCR”, “3. Internet” and “4. E-mail” and enables selection of one of these functions via the not shown remote controller. When “1. TV” is selected, TV viewing is enabled. When “2. VCR” is selected, a variety of settings such as making a recording reservation and a variety of operations such as replay or recording on the VCR are enabled, and replayed images are displayed on the display device 32. When “3. Internet” is selected, the multifunction TV 30 is connected to the Internet 12 via not shown communication lines and functions as a WWW browser. The WWW browser can be operated via the remote controller. When “4. E-mail” is selected, a mail creation screen or a mail reception screen is displayed, and transmission or reception of mail to/from the Internet 12 is enabled.

The display device 32 displays an incoming mail signal 32a indicating arrival of mail when new mail arrives. As the incoming mail signal can be displayed when any function is utilized, the user will be able to know the arrival of mail even while viewing TV, using the VCR or doing so-called Internet surfing.

When the same mail as in the second embodiment is transmitted from the mail transmitting terminal 10 and received, the mail reception screen indicating the same content as in the enlarged view of the display device 20a of the second embodiment is displayed on the display device 32. Then, the user may easily record or view programs or CM's in accordance with the same processing as in the first embodiment by selecting each button via the not shown remote controller instead of the keyboard 20c in the second embodiment. Specifically, the processing to output a signal from the infrared interface 14b in the first embodiment is replaced by the processing to directly control each function.

Fifth Embodiment

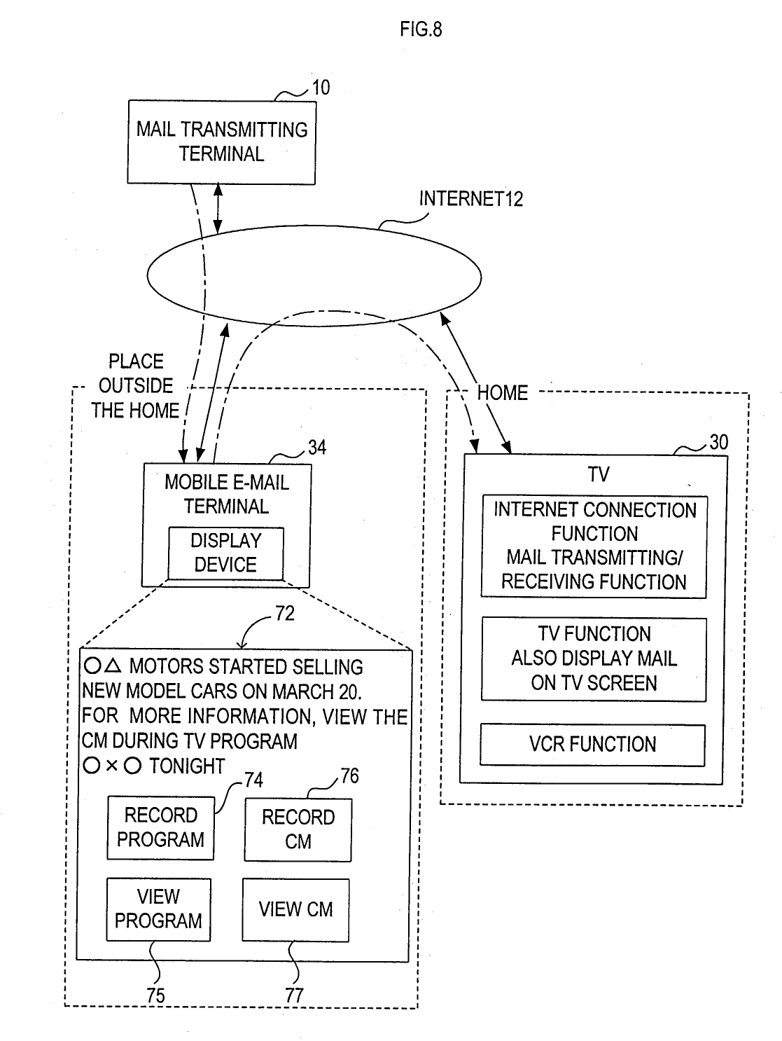

An example of receiving e-mail at a place outside the home and making a recording reservation by sending a recording instruction from the place to the TV at home via e-mail will be explained with reference to FIG. 8.

A mobile e-mail terminal 34 is a portable terminal provided with mail function, such as a PDA or a mobile phone, with which the user receives mail transmitted from a mail transmitting terminal 10 at the place outside the home. The received mail is displayed on the display device in the same manner as in the second embodiment. When the user pushes the program record button 74 of the mobile e-mail terminal 34 to input a recording instruction, e-mail including the recording instruction, the program start date and time, the program finish date and time, and the broadcast channel is transmitted as a recording reservation command to the TV 30 at home. In turn, the TV 30, which watches arrival of e-mail, receives the e-mail and makes a recording reservation in accordance with the recording instruction, the program start date and time, the program finish date and time, and the broadcast channel included in the e-mail. Thus, it is possible to easily make a recording reservation on the TV 30 at home even at the place outside the home.

In the present embodiment, the recording instruction corresponds to determination information in claim 11, and the program start date and time, the program finish date and time, and the broadcast channel correspond to obtaining information. The TV 30 corresponds to data receiving means, determination means, broadcast information obtaining means, and recording control means.

While the present embodiment has been explained with respect to the TV 30, the TV 30 may be replaced by either one of the apparatuses provided with mail receiving function described in the first embodiment through the fourth embodiment together with a VCR. Also, the mobile e-mail terminal 34 may be, for example, a computer terminal installed in an office.

Furthermore, if there are a plurality of recording means, it may be possible to select one of them for recording. For example, if there are a plurality of VCRs, it may be possible to select one of the VCRs to be used for recording.

While the recording reservation command is transmitted from the mobile e-mail terminal 34 to the TV 30 via e-mail, the instruction may be transmitted via other communication systems. It may be transmitted through the Internet or other communication networks.

Sixth Embodiment

It may be possible to provide a common VCR with the function to record a certain sponsor's CM's whenever such CM's are broadcasted. By this, every time the sponsor's CM is broadcasted, it is forcibly recorded. Therefore, the possibility that a user views the CM will be enhanced. If the sponsor delivers such VCRs to users for free, the number of viewers of the sponsor's CM's by means of broadcast will be increased. On the other hand, the users may obtain for free a VCR which also can be used in an usual manner. Accordingly, an advertisement system which is advantageous to both of the sponsor and the users can be achieved.

Making certain programs be recorded without fail instead of the above CM's may be used, for example, as a method for increasing the number of viewers when a new broadcast starts. Also, it may be used as a method to spread a new VCR device or the like.

It is determined whether or not a certain sponsor's CM is to be broadcasted by receiving the information about the broadcast time of the sponsor's CM via e-mail or the Web and determining whether or not the broadcast time has passed. Alternatively, it may be possible that a CM is encoded using a unique code for each sponsor and broadcasted, then the VCR receives the broadcast, decodes the code and determines whether the broadcast includes the certain sponsor's CM. In the case of determining whether or not a certain program is to be broadcasted, the information via e-mail or the Web may be used as well as the information via an Electronic Program Guide (EPG). The unique code for each sponsor in the present embodiment corresponds to the determination information as set forth in claim 12. And the VCR in the present embodiment corresponds to the data receiving means, the determination means and the recording control means as set forth in claim 12.

Seventh Embodiment

While a user may view the broadcast content recorded with a VCR by operating the VCR, an apparatus having mail receiving means, such as the mail receiving terminal 14, the mobile phone 20, the mail receiving terminal 24 or the TV 30 may be adapted to transmit an output command of the broadcast content recorded with the VCR through the infrared interface 14b, 20b or the digital connection interface 24b in accordance with the user's instruction. For example, when the program record button 64 or the CM record button 66 shown in FIG. 2, or the program record button 74 or the CM record button 76 shown in FIG. 5 is pushed, information such as the start date and time and the finish date and time of the program or the CM is stored according to the processing of program recording reservation or the processing of CM recording reservation described referring to FIG. 3. When the program view button 65 or the CM view button 67 shown in FIG. 2, or the program view button 75 or the CM view button 77 shown in FIG. 5 is pushed, it is determined whether the broadcast content has been recorded from the above mentioned stored dates and time. If the broadcast content has been recorded, an output command of the content is outputted to the VCR. This facilitates viewing of the recorded program or CM without operating the VCR.

In the present embodiment, the program view button 65, the CM view button 67, the program view button 75 and the CM view button 77 correspond to the instruction input means as set forth in claim 13, and the respective apparatuses including the infrared interface 14b, 20b or the digital connection interface 24b correspond to the output control means as set forth in claim 13, and the VCR corresponds to the recording means.

Eighth Embodiment

Instead of making a recording reservation in advance to record the required broadcast content, recording all the broadcasted contents may be possible. When the program view button 65 or the CM view button 67 shown in FIG. 2, or the program view button 75 or the CM view button 77 shown in FIG. 5 is pushed, an output command of the broadcast content is outputted via the infrared interface 14b, 20b or the digital connection interface 24b to the VCR if the broadcast start time of the broadcast content has already passed. This facilitates viewing of the recorded broadcast content without operating the VCR or the like. No need of making a recording reservation in advance leads to no failure to record, and facilitates viewing of the intended program or CM during or after the broadcast.

In the present embodiment, the program view button 65, the CM view button 67, the program view button 75 and the CM view button 77 correspond to the instruction input means in claim 13, and the respective apparatuses including the infrared interface 14b, 20b or the digital connection interface 24b correspond to the output control means in claim 14, and the VCR corresponds to the recording means. The mail receiving terminal corresponds to the e-mail receiving means.

While the description is mainly about the case of transmitting e-mail about advertisements from the mail transmitting terminal in the above embodiments, e-mail about the contents of programs may be transmitted from the mail transmitting terminal. In this case, names of TV personalities, musicians, scholars and the like in whom the recipient of the mail has interest are previously registered at the e-mail transmitting terminal or the host on the distribution side. Then, e-mail indicating “Mr./Ms.◯◯ will appear on the program ΔΔ.” is delivered to an appropriate user on the morning of the day of his/her appearance or the day before. This enable the user to make a recording reservation of the program in which the desired TV personality or the like appears using the above described reservation function within the e-mail.

### INDUSTRIAL APPLICABILITY

As described above, reservation recording of broadcast contents is easily performed and viewing of the broadcast contents is encouraged according to the present invention. Also, an increase in viewer rating of CM's included in the broadcast contents will enhance advertisement effects, thereby increase the sales, and ultimately vitalize a variety of related industries.

What is claimed is:

1. A system for encouraging viewing, comprising:
an e-mail transmission side apparatus for transmitting e-mail including obtaining information for obtaining a broadcast date and time and a broadcast channel; and
an e-mail receiving side system for receiving the e-mail and outputting the content of the e-mail to a user,
wherein said e-mail receiving side system includes:
e-mail receiving means for receiving e-mail;
instruction input means for inputting a recording instruction of the broadcast content by the user in accordance with the e-mail received by said e-mail receiving means;
broadcast information obtaining means for obtaining the broadcast date and time and the broadcast channel in accordance with the obtaining information;
recording control means for outputting, when the recording instruction is inputted by said instruction input means, at least either a recording reservation command to make a recording reservation of the broadcast content with the broadcast date and time and the broadcast channel obtained by said broadcast information obtaining means or a recording command to record the broadcast content with the broadcast channel once the broadcast date and time obtained by said broadcast information obtaining means has passed; and
recording means for receiving and recording the broadcast content in accordance with the recording reservation command or the recording command outputted by said recording control means.

2. A system for encouraging viewing, comprising:
an e-mail transmission side apparatus for transmitting e-mail including a message that a commercial will be broadcasted and obtaining information for obtaining the broadcast date and time and the broadcast channel of the commercial or the program during which the commercial is broadcasted; and
an e-mail receiving side system for receiving the e-mail and outputting the content of the e-mail to a user,
wherein said e-mail receiving side system includes:
e-mail receiving means for receiving e-mail;
instruction input means for inputting a recording instruction of the program or the commercial by the user in accordance with the e-mail received by said e-mail receiving means;
broadcast information obtaining means for obtaining the broadcast date and time and the broadcast channel of the program or the commercial in accordance with the obtaining information;
recording control means for outputting, when the recording instruction is inputted by said instruction input means, at least either a recording reservation command to make a recording reservation of the broadcast content with the broadcast date and time and the broadcast channel obtained by said broadcast information obtaining means or a recording command to record the broadcast content with the broadcast channel once the broadcast date and time obtained by said broadcast information obtaining means has passed; and
recording means for receiving and recording the program or the commercial in accordance with the recording reservation command or the recording command outputted by said recording control means.

3. The system for encouraging viewing according to claim 1 or 2, wherein said recording means records only the commercial part of the broadcast content.

4. A system for encouraging viewing, comprising:
an e-mail transmission side apparatus for transmitting e-mail including obtaining information for obtaining a broadcast date and time and a broadcast channel; and
an e-mail receiving side system for receiving the e-mail and outputting the content of the e-mail to a user,
wherein said e-mail receiving side system includes:
e-mail receiving means for receiving e-mail;
instruction input means for inputting an output instruction of the broadcast content by the user in accordance with the e-mail received by said e-mail receiving means;
broadcast information obtaining means for obtaining the broadcast date and time and the broadcast channel in accordance with the obtaining information; and
output control means for outputting, when the output instruction is inputted by said instruction input means, at least either an output reservation command to make an output reservation of the broadcast content with the broadcast date and time and the broadcast channel obtained by said broadcast information obtaining means or an output command to output the broadcast content with the broadcast channel once the broadcast date and time obtained by said broadcast information obtaining means has passed.

5. A system for encouraging viewing, comprising:
an e-mail transmission side apparatus for transmitting e-mail including a message that a commercial will be broadcasted and obtaining information for obtaining the broadcast date and time and the broadcast channel of the commercial or the program during which the commercial is broadcasted; and
an e-mail receiving side system for receiving the e-mail and outputting the content of the e-mail to a user,
wherein said e-mail receiving side system includes:
e-mail receiving means for receiving e-mail;
instruction input means for inputting an output instruction of the program or the commercial by the user in accordance with the e-mail received by said e-mail receiving means;
broadcast information obtaining means for obtaining the broadcast date and time and the broadcast channel of the program or the commercial in accordance with the obtaining information;
output control means for outputting, when the output instruction is inputted by said instruction input means, at least either an output reservation command to make an output reservation of the broadcast content with the broadcast date and time and the broadcast channel obtained by said broadcast information obtaining means or an output command to output the broadcast content with the broadcast channel once the broadcast date and time obtained by said broadcast information obtaining means has passed; and
output means for receiving and outputting the program or the commercial in accordance with the output reservation command or the output command outputted by said output control means.

6. The system for encouraging viewing according to any one of claims 1 to 5, further comprising point awarding means for awarding points when the recording instruction or the output instruction is inputted by said instruction input means.

7. An apparatus for encouraging viewing, comprising:
e-mail receiving means for receiving e-mail including obtaining information for obtaining broadcast date and time and a broadcast channel;
instruction input means for inputting a recording instruction of the broadcast content by the user in accordance with the e-mail received by said e-mail receiving means;
broadcast information obtaining means for obtaining the broadcast date and time and the broadcast channel in accordance with the obtaining information; and
recording control means for outputting to a recording apparatus, when the recording instruction is inputted by said instruction input means, at least either a recording reservation command to make a recording reservation of the broadcast content with the broadcast date and time and the broadcast channel obtained by said broadcast information obtaining means or a recording command to record the broadcast content with the broadcast channel once the broadcast date and time obtained by said broadcast information obtaining means has passed.

8. An apparatus for encouraging viewing, comprising:
e-mail receiving means for receiving e-mail including a message that a commercial will be broadcasted and obtaining information for obtaining the broadcast date and time and the broadcast channel of the commercial or the program during which the commercial is broadcasted;
instruction input means for inputting a recording instruction of the program or the commercial by the user in accordance with the e-mail received by said e-mail receiving means;
broadcast information obtaining means for obtaining the broadcast date and time and the broadcast channel of the program or the commercial in accordance with the obtaining information; and
recording control means for outputting to a recording apparatus, when the recording instruction is inputted by said instruction input means, at least either a recording reservation command to make a recording reservation of the broadcast content with the broadcast date and time and the broadcast channel obtained by said broadcast information obtaining means or a recording command to record the broadcast content with the broadcast channel once the broadcast date and time obtained by said broadcast information obtaining means has passed.

9. An apparatus for encouraging viewing, comprising:
e-mail receiving means for receiving e-mail including obtaining information for obtaining a broadcast date and time and a broadcast channel;
instruction input means for inputting an output instruction of the broadcast content by the user in accordance with the e-mail received by said e-mail receiving means;
broadcast information obtaining means for obtaining the broadcast date and time and the broadcast channel in accordance with the obtaining information; and
output control means for outputting to an output apparatus, when the output instruction is inputted by said instruction input means, at least either an output reservation command to make an output reservation of the broadcast content with the broadcast date and time and the broadcast channel obtained by said broadcast information obtaining means or an output command to output the broadcast content with the broadcast channel once the broadcast date and time obtained by said broadcast information obtaining means has passed.

10. An apparatus for encouraging viewing, comprising:
e-mail receiving means for receiving e-mail including a message that a commercial will be broadcasted and obtaining information for obtaining the broadcast date and time and the broadcast channel of the commercial or the program during which the commercial is broadcasted;
instruction input means for inputting an output instruction of the program or the commercial by the user in accordance with the e-mail received by said e-mail receiving means;
broadcast information obtaining means for obtaining the broadcast date and time and the broadcast channel of the program or the commercial in accordance with the obtaining information;
output control means for outputting to an output apparatus when the output instruction is inputted by said instruction input means, at least either an output reservation command to make an output reservation of the broadcast content with the broadcast date and time and the broadcast channel obtained by said broadcast information obtaining means or an output command to output the broadcast content with the broadcast channel once the broadcast date and time obtained by said broadcast information obtaining means has passed.

11. An apparatus for encouraging viewing, comprising:
data receiving means for receiving data including obtaining information for obtaining a broadcast date and time and a broadcast channel and determination information for determining whether to record the broadcast content or not;
determination means for determining whether to record the broadcast content or not in accordance with the determination information received by said data receiving means;
broadcast information obtaining means for obtaining the broadcast date and time and the broadcast channel in accordance with the obtaining information; and
recording control means for outputting to a recording apparatus, when recording is determined by the determination means, at least either a recording reservation command to make a recording reservation of the broadcast content with the broadcast date and time and the broadcast channel obtained by said broadcast information obtaining means or a recording command to record the broadcast content with the broadcast channel once the broadcast date and time obtained by said broadcast information obtaining means has passed.

12. An apparatus for encouraging viewing, comprising:
data receiving means for receiving determination information for determining whether to record the broadcast content or not;
determination means for determining whether to record the broadcast content or not in accordance with the determination information received by said data receiving means; and
recording control means for outputting a recording command to record the broadcast content to a recording apparatus when recording is determined by the determination means,
wherein the determination information is included in the broadcast content.

13. The system for encouraging viewing according to any one of claims 1 to 3, wherein said receiving side system further comprises:
instruction input means for inputting an output instruction of the broadcast content recorded with said recording means by the user in accordance with the e-mail;
output control means for outputting an output command to output the recorded broadcast content when the output instruction is inputted by said output instruction input means; and
output means for outputting the broadcast content recorded with said recording means in accordance with the output command.

14. A system for encouraging viewing, comprising:
an e-mail transmission side apparatus for transmitting e-mail including obtaining information for obtaining a broadcast date and time and a broadcast channel; and
an e-mail receiving side system for receiving the e-mail and outputting the content of the e-mail to a user,
wherein said e-mail receiving side system includes:
e-mail receiving means for receiving e-mail;
recording means for receiving broadcast and recording the broadcast content as needed;
instruction input means for inputting an output instruction of the broadcast content recorded with said recording means by the user in accordance with the e-mail received by said e-mail receiving means;
output control means for outputting an output command of the broadcast content when an output instruction is inputted by said output instruction input means; and
output means for outputting the broadcast content recorded with said recording means in accordance with the output command.

15. A computer-readable recording medium containing programs for making a computer system operate as e-mail receiving means, instruction input means, broadcast information obtaining means, recording control means, recording means, output control means, output means, data receiving means and determination means in the system for encouraging viewing or the apparatus for encouraging viewing according to any one of claims 1 to 13.
